(19) United States
(12) Patent Application Publication
(10) Pub. No.: US 2012/0254166 A1
(43) Pub. Date: Oct. 4, 2012

(54) Signature Detection in E-Mails

(75) Inventors: Gaurav AGARWAL, Balrampur (IN); Shailesh Kumar, Hyderabad (IN)

(73) Assignee: Google Inc., Mountain View, CA (US)

(21) Appl. No.: 13/219,864

(22) Filed: Aug. 29, 2011

(30) Foreign Application Priority Data
Mar. 30, 2011 (IN) 1018/CHE/2011

(51) Int. Cl. G06F 17/30

(52) U.S. Cl. 707/730; 707/E17.084

(57) ABSTRACT

In an electronic discovery search tool, non-substantive information, such as signatures in e-mail, can bias a search tool and add processing time. A method and system for identifying recurring non-substantive text in documents has been developed so that non-substantive text may be processed or ignored by the search tool, as needed.

### CROSS-REFERENCE TO RELATED APPLICATIONS

This application claims priority to Indian Provisional Application No. 1018/CHE/2011, filed Mar. 30, 2011, which is incorporated by reference herein in its entirety.

### BACKGROUND

In response to a litigation hold, parties to a litigation are faced with the task of processing large numbers of documents. In the past, parties required to produce relevant documents were faced with the task of printing and collecting all of a party's documents for manual review. Parties receiving large numbers of relevant documents from an opposing party were faced with manual review of all the printed documents to evaluate their contents for relevance. Since the advent of electronic discovery (e-discovery), the task has evolved to avoid the necessity of paper copies. In addition, simple electronic search techniques are used to reduce the number of documents processed, by identifying documents that appear to be relevant to a litigation.

However, with the huge numbers of documents that must be searched for relevance to a litigation, significant processing resources and time may be required to evaluate all the documents. Since e-mail has become the most common source of communication, a high percentage of the corpus of documents being searched may be e-mails. Thus, a high percentage of the time and expense for processing electronic documents is dedicated to electronically processing e-mail. E-mails frequently contain text other than the substantive message for which the e-mail has been created, such as automatically inserted signature blocks, confidentiality notices, and names of employers. This “boiler-plate” text contains almost no information about the case and yet consumes a significant amount of the processing time needed to analyze e-mails.

### BRIEF SUMMARY

Embodiments disclose methods and systems for efficiently analyzing the contents of sets of electronic documents, and particularly for improving the analysis of sets of e-mails by recognizing and evaluating repetitive text in the e-mails.

In an embodiment, a method is described for identifying non-substantive portions of text in a set of e-mails. Text is captured from a set of e-mails, and statistics are calculated regarding the frequency with which the text appears. Based on these statistics, the text may be identified as non-substantive text. Non-substantive text portions are then marked or tagged as such, so that electronic discovery or other software can identify them.

In an embodiment, the set of documents in which non-substantive text is identified is a subset of a larger set of documents. Non-substantive text identified and marked in the subset may be marked in the larger set of documents as well.

In an embodiment, a checksum is generated for each block of text. Statistics on checksums are calculated to determine the frequency of blocks of text.

In an embodiment, a system for identifying non-substantive text in documents is described. The system includes a filter to create a set of documents from the entire corpus of documents of the enterprise, a capturer to capture blocks of text from these filtered documents, a checksum generator that generates checksums from blocks of text, a calculator to calculate the frequency of occurrence of each checksum in the filtered set of documents, and a tagger for tagging blocks of text as non-substantive when the frequency of occurrence is above a threshold.

### BRIEF DESCRIPTION OF THE DRAWINGS/FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1 is a diagram of a system containing documents.

FIG. 2 is a flow diagram of a method for identifying non-substantive text in documents.

FIG. 3 is a diagram of a signature detector according to an embodiment of the present invention.

FIG. 4 is a sample table of identified non-substantive text in accordance with an embodiment.

FIG. 5 is a diagram of an example computer system that can be used to implement an embodiment of the present invention.

### DETAILED DESCRIPTION

While the present invention is described herein with reference to illustrative embodiments for particular applications, it should be understood that the invention is not limited thereto. Those skilled in the art with access to the teachings provided herein will recognize additional modifications, applications, and embodiments within the scope thereof and additional fields in which the invention would be of significant utility.

In the detailed description of embodiments that follows, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

### Overview

Embodiments disclosed herein relate to efficiently analyzing the contents of sets of electronic documents, and particularly to improving the analysis of sets of e-mails by recognizing and evaluating repetitive “boiler-plate” text in the e-mails. Embodiments disclose methods and systems for processing large numbers of e-mails in response to a litigation hold, but other benefits are attainable in other applications, as may be apparent to a person skilled in the relevant art(s).

A document referred to herein may be any type of electronic file containing text, including but not limited to e-mail, text message, distribution list, spreadsheet, text file, web page, bit map, or graphics file. One of ordinary skill would recognize other types of electronic files are also electronic documents according to the present invention. Electronic documents, as referred to herein, are accessible by known electronic communications methods and may be stored in a variety of storage media, including but not limited to electronic media, such as Random Access Memory (RAM) or Read Only Memory (ROM), magnetic media, such as tape drives, floppy disks or hard disk drives (HDD), and optical media, such as Compact Disks (CD) or Digital Video Disks (DVD). Embodiments may be applicable to any type of electronic document but the description of embodiments presented herein will be directed to e-mail communications.

In response to a litigation hold, a legal team identifies a corpus of documents to be searched to identify documents relevant to the litigation. Based on the facts of the case and the parties involved, parameters of a search are identified, a search is performed, and a set of potentially relevant documents is identified. The storage area to be searched may be identified by physical storage devices, logical storage partitions, document security designations, or by any other means known to one of ordinary skill in the art. In an exemplary embodiment, the corpus of documents may be contained within a single computer or storage device, or the corpus of documents may be spread across multiple servers, client computers, storage devices and other components that may or may not be interconnected.

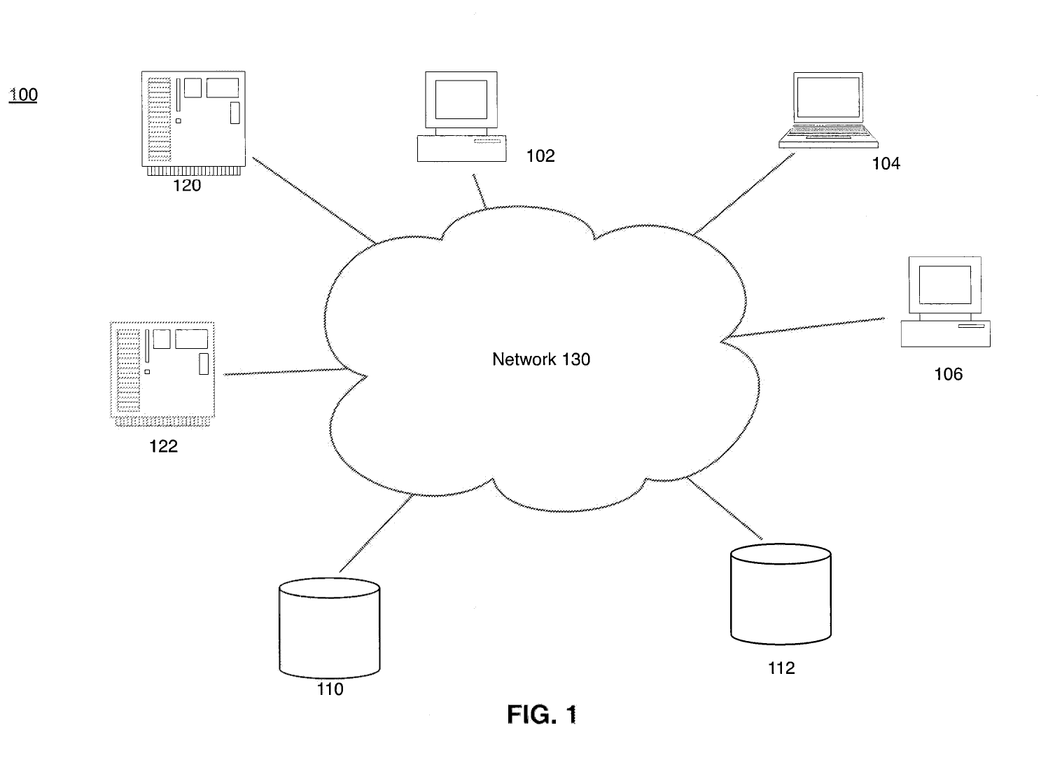

FIG. 1 is a diagram of a system 100 in which a corpus of documents is contained.

Although system 100 is described herein with respect to a limited number of devices and a single network, the system 100 in FIG. 1 is provided as a non-limiting example for explanation purposes. As shown in FIG. 1, system 100 includes processing devices, such as servers 120 and 122, and client computers 102, 104 and 106. In addition, system 100 includes storage devices 110 and 112. The devices in system 100 are interconnected by network 130. Network 130 may be a local area network (LAN), wide area network (WAN), intranet, interne, WI-FI, cell phone network, or any other wired or wireless network for communication between computing devices. One of ordinary skill in the art will recognize that there are many possible variations on the number and interconnection of computing and storage devices in which all or part of the corpus of documents could be contained and searched according to the present invention. In addition, the system components may be stand alone or may be interconnected by one or more networks of various types.

Using one or more computing devices, the corpus of documents is searched for potentially relevant documents. In the system 100, a search may be initiated, for example, at client computer 102. The corpus of documents may be isolated to documents stored within client computer 102. In another embodiment, the corpus may include documents contained within storage device 110 and/or server 120.

Regardless of the storage configuration containing the corpus of documents, the set of documents identified by the search may include a variety of electronic document types, as discussed above. Alternatively, the search may be tailored to only search for documents of a particular type. Thus, the corpus of documents can be searched for all e-mails related to the search criteria. The quality of a document search may be determined by the resulting set of documents.

The set of e-mails identified in the search results may be reviewed for relevance to the litigation. The review process may require significant time and resources if the set of identified e-mails is very large. The result of the review process may be limited to identifying a document as relevant or non-relevant. In such a case, a high quality search is one that returns a large number of relevant documents and a relatively small number of non-relevant documents.

E-mail messages contain many different fields which may be used in electronic discovery tools. Most of the commonly used fields of an e-mail provide information that can be used to improve the processing of a large set of e-mails. The origination date and time of an e-mail can be used to determine whether the e-mail was created in the timeframe pertaining to the litigation hold. E-mails outside that timeframe may be excluded from the search results. In addition, the origination date and time of an e-mail may provide evidence of the timing of events associated with a litigation. Search criteria can be modified according to the time period of interest.

The “From:”, “Sender:”, and “Reply-To:” fields, if used, provide information related to the source of an e-mail. An e-mail containing a keyword used in the search criteria may identify parties of interest to a litigation. The search criteria can be updated to search for e-mails and other documents from those parties. Similarly, the “To:”, “CC:”, and “BCC:” fields can also be used to identify parties of interest.

The “Subject:” field of an e-mail may identify the topic of the e-mail or may contain the beginning of the e-mail message. This field may be an important target for keyword searches.

The majority of the text in an e-mail is contained in the “Body:” field. It has the greatest capacity for text and therefore the greatest capacity for providing information. It also requires the greatest amount of processing in a search based on keywords and/or queries. Typically, the most significant content in an e-mail is contained in the body. For purposes of this description, the significant content in an e-mail, which is usually the primary purpose for generating the e-mail, will be referred to herein as the substantive text. Other content present in the body of an e-mail will be referred to generally herein as non-substantive text, unless otherwise specified. The substantive text is often an e-mail's most valuable section for determining relevance to a litigation and for providing information relevant to the litigation. Substantive text in a set of e-mails is typically the main target for keyword searches and queries to identify relevant documents. Substantive text can be parsed using various text processing techniques. For example, syntactic text processing techniques can be used to capture phrases or proper names. In another example, semantic text processing techniques are used to identify relationships between words in the context of a litigation. By these or other techniques, previously unknown keywords can be identified from the substantive text of e-mails. The content of the substantive text can also be used to classify or group a set of documents by subject matter or to identify spam e-mail.

Non-substantive text, by contrast, may not have as much value to reviewers of documents in a litigation. In fact, some non-substantive text can be detrimental to the quality of a search in the iterative process described above. Several types of non-substantive text are possible in an e-mail. A non-exhaustive list of examples of non-substantive text includes signatures, confidentiality clauses, headers, company names, contact information, hyperlinks, author's title/designation, attachments and contents of preceding e-mails in a thread, also referred to as the “quoted text” in an e-mail. Non-substantive text may be any text that is automatically incorporated into an e-mail by the sender, the e-mail service, the sender's or recipient's employer or any other source or handler of an e-mail prior to delivery to the recipient. Non-substantive text is usually not unique to a particular e-mail, but rather is found in all or a set of e-mails having a common origin. Signature text added at the bottom of an e-mail by a sender is one of the most commonly recognized forms of non-substantive text. Signature blocks typically remain constant for a period of time but eventually change for a variety of reasons. As indicated by the broad definition, non-substantive text can take many forms and be found in different parts of the body of an e-mail.

The various types, locations and contents of non-substantive text can make it very difficult to identify in a single e-mail. However, when a large number of e-mails are examined, and their contents are compared, it is possible to identify patterns or identically repetitive text, which may be non-substantive text, in accordance with an embodiment. The contents of fields other than the body of an e-mail may provide hints to the non-substantive text likely to be found within an e-mail. For example, it may be known that a signature block is present at the bottom of all e-mails from a particular e-mail address. In another example, a particular employer may require each employee or a set of employees to have a standardized confidentiality paragraph in the last three lines of every e-mail. Thus, the analysis process can simply capture or remove those three lines of text, as needed, from every e-mail sent by those employees of that employer. When there is no prior knowledge and no hint to the non-substantive text in a set of e-mails, according to an embodiment, the text may be broken up by paragraphs, when possible.

In an embodiment, in order to identify a particular block of text as non-substantive text, a set of e-mails is analyzed. The set of e-mails may be analyzed to determine the frequency of a particular block of text. If a particular block of text is repeated with some threshold level of frequency in the set of e-mails, the block of text is identified as non-substantive and e-mails containing that unit of text may be marked or tagged to indicate that they contain that particular non-substantive text.

Determining the frequency of repetition of a unit of text may begin with separating the entire body of an e-mail into corresponding blocks of text. Individual blocks of text may be associated with a unique identifier. A table or other index which matches unique identifiers and corresponding blocks of text may be kept.

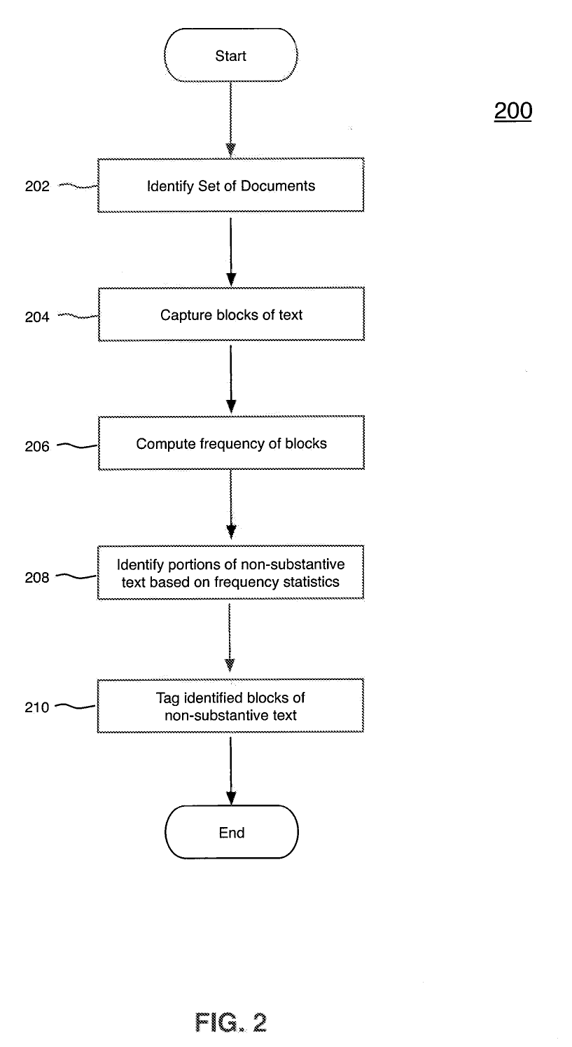

FIG. 2 is a flow diagram for a method 200 of identifying non-substantive text in a set of documents. At block 202, a set of text documents is identified. The text documents may be e-mails, word processor files, spreadsheets, presentations, or any other type of text document. Documents may be relevant to a litigation, and may belong to a particular custodian or user.

At block 204, the set of documents is scanned to capture unique blocks of text. A block of text may be defined, for example and without limitation, as a paragraph, line, sentence, or other unit of text of an e-mail. In an embodiment, only specified blocks of text of an e-mail are captured. Because most non-substantive text appears either at the top or the bottom of an e-mail message, for example, the top three and bottom three paragraphs may be captured.

At block 206, captured text blocks are compared to each other to determine the frequency of each text block. Captured text blocks may be compared to one another using any known method of doing so. For example, captured text blocks may be compared based on a direct text comparison. Captured text blocks may also be compared based on a natural language comparison. Other comparison methods may compare captured text blocks based on the frequency of words that occur in each text block or a probability distribution or histogram that represents words in each captured text block. Statistics regarding the number of occurences of each text block may be computed.

At block 208, based on the statistics computed at block 206, portions of text may be identified as non-substantive. For example, the most frequently found block of text may be identified as non-substantive, since it is likely a signature block found in all or most of the documents in the set. Multiple blocks of text may be identified as non-substantive based on the frequency of their occurrence.

At block 210, the blocks of text identified as non-substantive are marked or tagged. The marking or tagging may serve as a signal to electronic discovery software, for example, to omit the marked or tagged block of text from indexing, searching, or other operations.

In an embodiment, the documents identified at block 202 of method 200 are e-mails from a particular user. For example, in a document review, a user who has his documents placed on litigation hold is known as a custodian. E-mails sent by that custodian may be the documents used in method 200. In this way, all non-substantive text in that user's e-mails may be identified after method 200 is performed on the custodian's sent e-mails. As described with respect to block 202 of method 200, documents may include text documents other than e-mails, including but not limited to documents such as word processor files, spreadsheets, or presentataions.

Although embodiments are described with reference to identifying non-substantive text in e-mails, non-substantive text may be present in other types of documents as well. For example, web pages from a company's web site may have the same menu text repeated throughout the web site. Frequently occurring text such as this may be identified as non-substantive, in accordance with method 200, such that a review process is not biased by the non-substantive text.

Similarly, documents sent to and from members of a legal department may contain text such as “Privileged and Confidential” in the header or footer of the documents. This text also may not assist in the review process, and may be identified as non-substantive text in accordance with method 200.

Text included in the body of a forwarded e-mail or in the body of a replied-to e-mail may also be identified as non-substantive. In a long e-mail thread, or in an e-mail that has been sent or forwarded to a large number of people, reviewing the same e-mail multiple times may be wasted effort. Thus, text duplicated across a corpus of e-mails may be identified as non-substantive, since the duplicated text may not assist in the review process.

In an embodiment, a set of documents are filtered from the entire corpus of documents of the enterprise. Filters may be individual filters, such as all documents originating from a particular sender, or all documents sent to a particular receiver within a specified time window. These filters may also be group filters. For example, documents from all individuals associated with a particular group, such as a department, project, mailing list, or committee. Further, filters may be enterprise filters, such as all documents from all individuals within an enterprise. Once a flier is defined, all documents that satisfy the filter may be referred to as the filtered set of documents. Identifying non-substantive text in accordance with method 200 of FIG. 2 may be performed on the filtered set of documents.

In an embodiment, captured blocks of text are compared to each other, as in block 206 of method 200, using a checksum function. For each captured unique block of text, a checksum may be computed. A checksum function takes data, such as text, and calculates a fixed size representation of that data. The fixed size representation is known as the checksum. If two different elements of data are provided to a checksum function, the returned checksums will be different, while a checksum function performed twice on the same element of data will return the same checksum twice. Thus, the checksum may be considered a unique representation of an individual block of text. In this way, checksums may be used to determine whether two elements of data are identical.

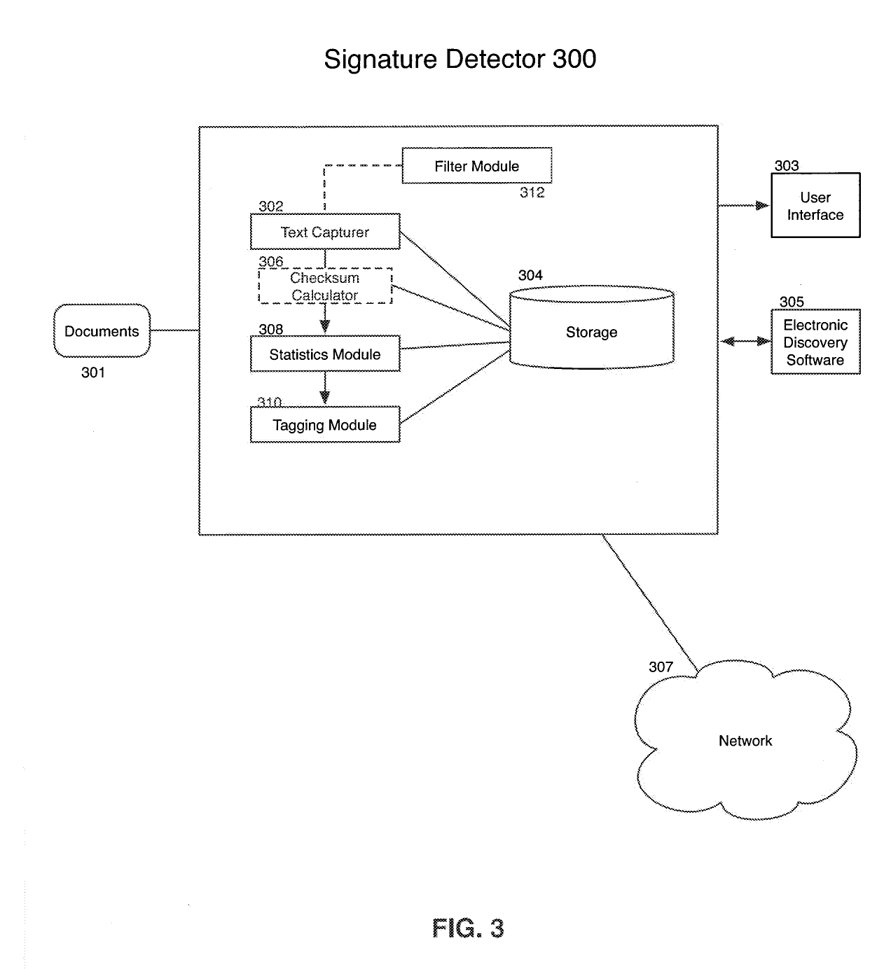

Thus, in an embodiment, for each captured block of text, a checksum may be calculated. The set of calculated checksums may be analyzed to determine the frequency at which each checksum occurs in the set of documents, as described with respect to block 208. The checksum that appears the most, or the top 2 or 3 checksums, may likely represent a signature block or other non-substantive text contained in a set of e-mails. The text corresponding to the frequently occurring checksums may be marked as non-substantive text. FIG. 3 is an illustration of a system for using checksums to identify non-substantive text in a set of documents.

In an embodiment, the set of text documents identified in block 202 may be a training set of documents. For example, there may be 10,000 e-mails from a particular user placed on litigation hold. Comparing unique blocks of text from 10,000 e-mails may be a lengthy process. Instead, a representative sample of, for example, 500 e-mails may be used as a training set. In addition to identifying specific non-substantive text, the training set may be used to determine non-substantive portions of the e-mails in the training set, such as the bottom paragraph. Using this data, the same paragraph of the remaining set can be marked as non-substantive text without needing to further analyze the larger set.

Thus, in an embodiment, the training set of documents may be selected as a representative sample to accurately mark non-substantive text in the larger set of documents. For example, it may be desirable to mark non-substantive text in all e-mails sent by a particular user on litigation hold. Thus, accordingly, a subset of the e-mails sent by that particular user may be used as a training set. Statistics determined based on the training set may be used to determine non-substantive text in the overall set of documents. Similarly, if marking non-substantive text in a set of e-mails from a particular department in a company is desired, a subset of those e-mails may be used as a training set.

In an embodiment, captured blocks of text are normalized to decrease the number of unique blocks captured. Normalizing the blocks of text may include, for example and without limitation, deleting spaces and tabs, deleting special characters, deleting special tags such as HTML or XML tags within the text, and/or making all characters the same case.

Non-substantive text portions, such as signatures or disclaimers, are generally consistent over long periods of time. Thus, information regarding changes to portions of non-substantive text may be useful. In an embodiment, differences in non-substantive text may provide further insight or clues of the substance of documents being reviewed. For example, an employee may list his title in the signature block of his e-mail messages. A change in the non-substantive text may allow a reviewer to note that a particular custodian changed titles during the period of litigation hold. Additionally, changes in the non-substantive text may allow a user to group a set of e-mails into logical groups to be used in a document review.

Identifying non-substantive text may also be useful in a document review environment when reviewing documents for privilege. The consequences of disclosing documents subject to attorney-client or other legal privilege can greatly affect a party's case. Often, e-mails from an attorney or a legal department contain disclaimers at the top or bottom of the e-mail message. Such disclaimers may read, for example and without limitation, “Privilege: Attorney/Client Confidential” or other similar text. Thus, if these disclaimers or other portions of text are consistent across multiple e-mails, the documents may be automatically marked as potentially privileged based on the non-substantive text, such that they place reviewers on notice that these documents need careful review.

Non-substantive text may provide an indication of confidentiality or privileged subject matter. Thus, determining e-mail characteristics by the above methods may eliminate additional review steps and improve the efficiency of subsequent review processing.

Marking sections of text as non-substantive may be useful in other respects as well. Because non-substantive text may not provide much or any useful information, in an embodiment, non-substantive text can be ignored by other processes. For example, when searching a large corpus of documents, sections of text that are marked as non-substantive may be skipped by the searching process. Since non-substantive text may make up a large portion of the text in a corpus, this may result in significant time savings.

Further, when searching a large corpus of documents, text contained in non-substantive portions may cause the search to return too large of a result set. For example, a user may want to search for e-mails that mention a particular company name. The company's name may also be part of the custodian's e-mail address, contained in that custodian's e-mail signature. If non-substantive text is not identified as such, the user's search will return e-mails mentioning the company's name as well as e-mails from that custodian, potentially creating a very large result set with irrelevant results. However, if the custodian's e-mail signature is marked as non-substantive text, that text may be excluded from searching, thus reducing the possibility that the user's search result set is polluted with irrelevant results. In some cases, non-substantive text occupies a disproportionately large part of the body of an e-mail but contains very little, if any, substantive information. Thus, much of the time spent searching the body of an e-mail for matches to a keyword or query is wasted.

When the results of a search are reviewed, the relevant documents are identified. Keywords are identified in both the relevant and non-relevant documents. The frequency of keywords in a set of relevant documents suggest a value in using those keywords in a subsequent search. Unfortunately, keywords found in non-substantive text can alter this process. Keywords from non-substantive text may be frequently found and used in subsequent searches with little or no benefit. Since those unhelpful keywords occur so often, they may preclude the inclusion of truly valuable new keywords from the subsequent search criteria. In addition, keywords found in the same documents as previously known keywords may imply a relationship between those words or cause some weight to be attributed to those keywords. Thus, words present in the non-substantive portions of an e-mail can negatively influence the results. Words in the non-substantive text are effectively “noise” that may bias the calculations used to determine new keywords. Biased calculations produce low quality search criteria for subsequent searches. Thus, identifying and removing predictable non-substantive text from analysis may improve the speed and quality of subsequent searches.

In an embodiment, if a non-substantive piece of text is identified as a signature block, it may be further parsed to extract specific fields such as the full name, job title, contact information, or other fields. This information may be used to update a contact list or list of custodians, and may be done automatically or with confirmation by a user.

Many electronic discovery software packages calculate statistics on documents after collecting a corpus of documents from a business. These statistics may include word counts for particular words, the total amount of text to be reviewed, or other desired statistics. As explained above, eliminating non-substantive text from the calculation of statistics may allow the resulting statistics to be more useful to the users of electronic discovery software. Over an entire litigation, this can result in significant savings in the total processing time.

FIG. 3 is an illustration of an exemplary signature detector 300 that may be used to implement various embodiments described herein. Signature detector 300 receives documents 301. Documents 301 may be stored in a database or other similar repository. Signature detector 300 contains a text capturer 302. Text capturer 302 may be configured to capture unique blocks of text, in accordance with block 204 of method 200. Unique blocks of text may be stored in storage 304.

Statistics module 308 may receive the captured blocks of text from text capturer 302 or storage 304, and compute the frequency of each block of text, in accordance with block 206 of method 200.

Signature detector 300 may also contain tagging module 310. Using the statistics from statistics module 308, tagging module 310 may be configured to mark the portions of the documents with non-substantive text or signatures to be used in a document review environment.

Signature detector 300 may also contain checksum generator 306. The results of checksum generator 306 may be used by statistics module 308. Statistics module 308 may take the results of checksum generator 306, and calculate the frequency of each checksum calculated, in accordance with block 206 of method 200.

Checksum generator receives captured text from text capturer 302 or storage 304 and generates checksums for each block of text captured. Checksum generator 306 may use any well-known method of generating a checksum from a text string, such as MD5 hash.

Signature detector 300 may also include a filter module 312. In accordance with embodiments, filter module 312 may filter documents 301 according to specified criteria. Filtered documents may be provided to text capturer 302.

Signature detector 300 may also be connected to user interface 303. User interface 303 may allow a user to control the operation of signature detector 300. For example, user interface 303 may allow a user to view the statistics from statistics module 308, and select checksums to be tagged as non-substantive text.

Signature detector 300 may also be connected to electronic discovery software 305. In this configuration, electronic discovery software 305 may communicate a set of documents to signature detector 300 to identify and tag non-substantive text. Electronic discovery software 305 may be configured to recognize tags applied by tagging module 310 and process tagged text accordingly.

In an embodiment, signature detector 300 may be implemented on a standalone device connected to a network 307, including but not limited to a local area network, medium area network, or wide area network such as the Internet. Signature detector 300 may also be implemented as part of another networked device.

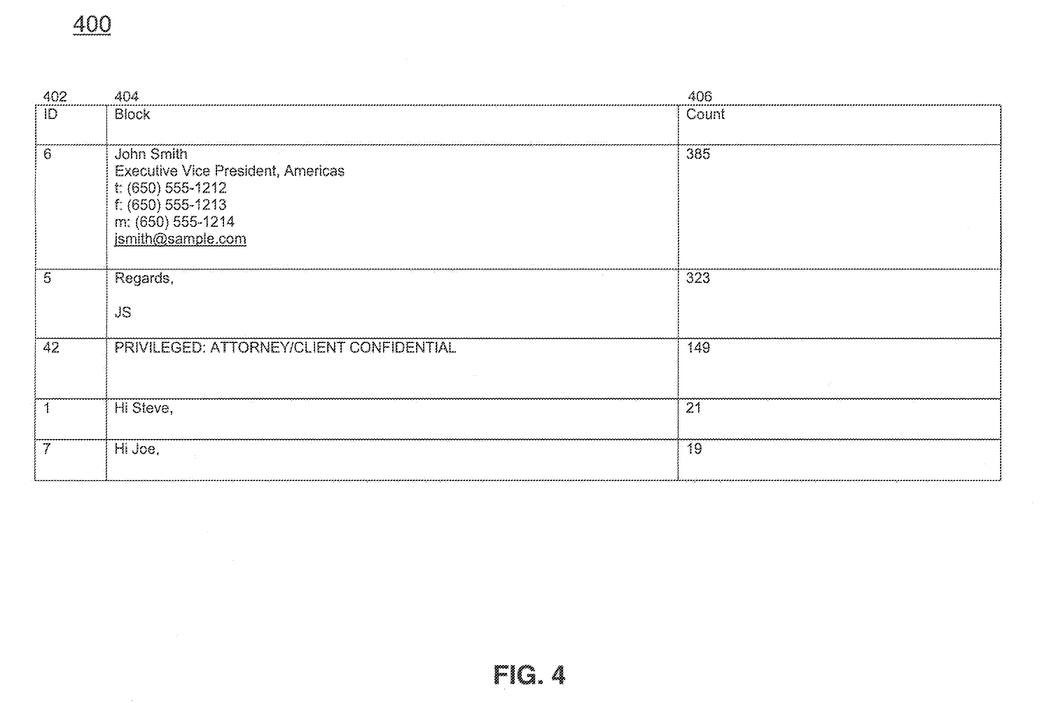

An example execution of method 200 is shown in FIG. 4. FIG. 4 is a portion of a table 400 containing blocks of text captured from a set of 400 e-mails. ID column 402 may provide a unique identifier for each block of text found in an e-mail message, such as, for example, a checksum. Block column 404 may display the actual text block captured from e-mail messages. Count column 406 may display the number of occurences for each text block captured.

As shown in the example of table 400, the user's signature, represented by ID number 6, occurs 385 times in the set of 400 e-mails. Further, ID number 5 appears 323 times in the set of 400 e-mails. ID number 42, a block of text denoting that the e-mails containing that block of text are privileged, appears 149 times.

Thus, in accordance with embodiments described herein, the user's signature represented by ID number 6 may be tagged as non-substantive text in the set of 400 documents. Additionally, if the set of 400 documents represented a training set or a subset of a larger set of documents, blocks of text matching the user's signature may also be tagged as non-substantive in the larger set of documents.

Further, the e-mails containing the occurences of the privileged text may be marked as potentially privileged. Again, if the 400 documents represented a training set, documents in the larger set containing text matching the privileged text may be marked as potentially privileged as well.

In a further embodiment, statistics on captured portions of text may be useful to group e-mails into logical sets. Using the example contained in table 400, the e-mails which resulted in rows representing ID 1 and ID 7 may be grouped together. Thus, a user may be able to review all e-mails to “Steve” separately from e-mails to “Joe.”

In one embodiment, less stringent requirements may be used to identify non-substantive text. For example, a block of text from a first e-mail that is very similar but not exactly the same as blocks of text from other e-mails, may also be identified as non-substantive text. Slightly different blocks of text over a large set still may represent non-substantive text, but checksums would not match. Thus, another means for identifying similar blocks of text may be necessary.

For example, the term frequency-inverse document frequency weight (TF-IDF) is a weight often used in comparing the importance of a word to a document in a set of documents. The TF-IDF weight of a given term increases as the frequency of the term in a document increases, and decreases as the frequency of the term in the corpus increases. Signature detector 300 or another system implementing method 200 may calculate the TF-IDF weight of various terms in a captured block of text, and compare the calculated TF-IDF weights to TF-IDF weights of other blocks of text to determine whether two blocks of text are nearly identical. Other blocks of text may with similar TF-IDF weights may then be identified and tagged as non-substantive.

In an embodiment, non-substantive text may be categorized by signature detector 300 or another system implementing method 200. For example, a particular set of e-mails may have both a signature block as well as a disclaimer block. The signature detector, for example, may categorize the blocks as their individual types. In this embodiment, if the non-substantive text tagging is used by an electronic discovery software, the electronic discovery software may be configured to search signature blocks but not disclaimer blocks, or vice versa.

The signature detector described herein can be implemented in software, firmware, hardware, or any combination thereof, The signature detector can be implemented to run on any type of processing device including, but not limited to, a computer, workstation, distr^{.} buted computing system, embedded system, stand-alone electronic device, networked device, mobile device, set-top box, television, or other type of processor or computer system.

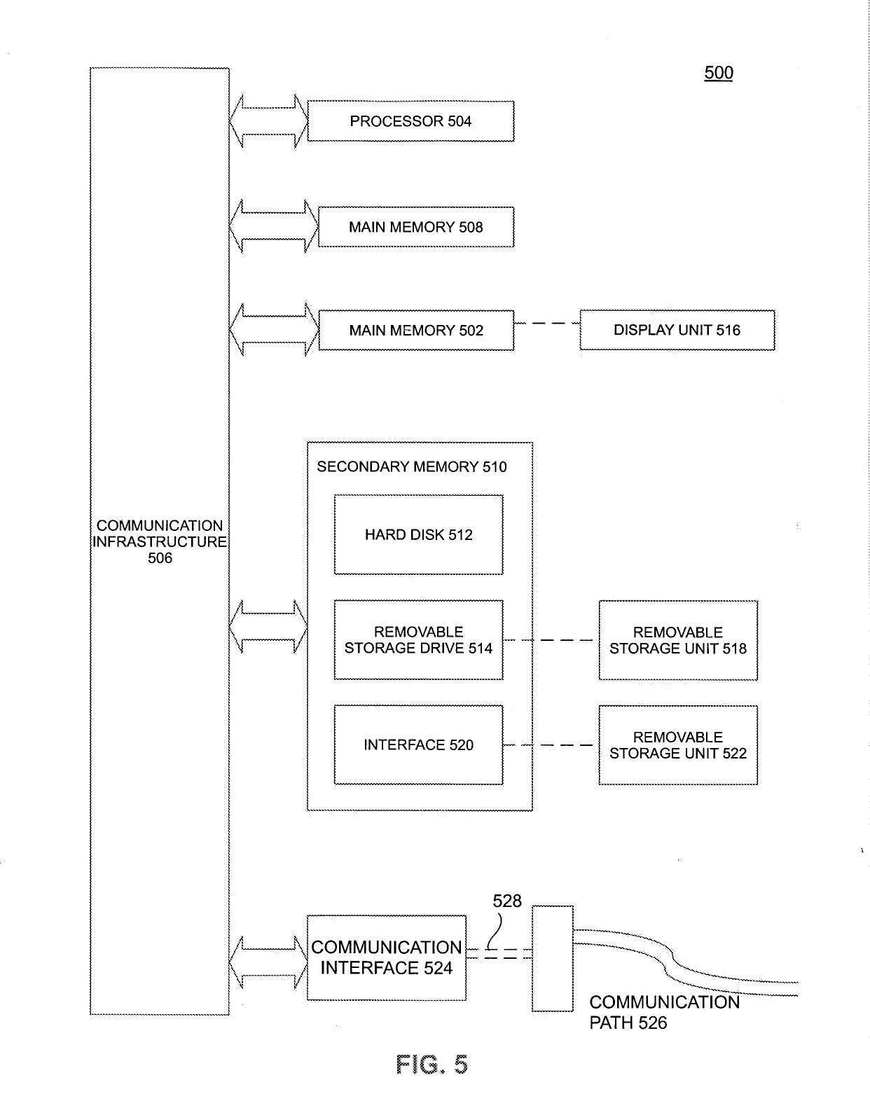

Various aspects of the present invention can be implemented by software, firmware, hardware, or a combination thereof. FIG. 5 illustrates an example computer system 500 in which the embodiments, or portions thereof, can be implemented as computer-readable code. For example, signature detector 300 carrying out method 200 of FIG. 2 can be implemented in system 500. Various embodiments of the invention are described in terms of this example computer system 500.

Computer system 500 includes one or more processors, such as processor 504. Processor can be a special purpose or a general purpose processor. Processor 504 is connected to a communication infrastructure 506 (for example, a bus or network).

Computer system 500 also includes a main memory 508, preferably random access memory (RAM), and may also include a secondary memory 510. Secondary memory 510 may include, for example, a hard disk drive and/or a removable storage drive. Removable storage drive 514 may include a floppy disk drive, a magnetic tape drive, an optical disk drive, a flash memory, or the like. The removable storage drive 514 reads from and/or writes to removable storage unit 518 in a well known manner Removable storage unit 518 may include a floppy disk, magnetic tape, optical disk, etc. which is read by and written to by removable storage drive 514. As will be appreciated by persons skilled in the relevant art(s), removable storage unit 518 includes a computer usable storage medium having stored therein computer software and/or data.

In alternative implementations, secondary memory 510 may include other similar means for allowing computer programs or other instructions to be loaded into computer system 500. Such means may include, for example, a removable storage unit 522 and an interface 520. Examples of such means may include a program cartridge and cartridge interface (such as that found in video game devices), a removable memory chip (such as an EPROM, or PROM) and associated socket, and other removable storage units 522 and interfaces 520 which allow software and data to be transferred from the removable storage unit 522 to computer system 500.

Computer system 500 may also include a communications interface 524. Communications interface 524 allows software and data to be transferred between computer system 500 and external devices. Communications interface 524 may include a modem, a network interface (such as an Ethernet card), a communications port, a PCMCIA slot and card, or the like. Software and data transferred via communications interface 524 are in the form of signals which may be electronic, electromagnetic, optical, or other signals capable of being received by communications interface 524. These signals are provided to communications interface 524 via a communications path 526. Communications path 526 carries signals and may be implemented using wire or cable, fiber optics, a phone line, a cellular phone link, an RF link or other communications channels.

In this document, the terms “computer program medium” and “computer usable medium” are used to generally refer to media such as removable storage unit 518, removable storage unit 522, and a hard disk installed in hard disk drive 512. Computer program medium and computer usable medium can also refer to one or more memories, such as main memory 508 and secondary memory 510, which can be memory semiconductors (e.g. DRAMs, etc.). These computer program products are means for providing software to computer system 500.

Computer programs (also called computer control logic) are stored in main memory 508 and/or secondary memory 510. Computer programs may also be received via communications interface 524. Such computer programs, when executed, enable computer system 500 to implement the embodiments as discussed herein. In particular, the computer programs, when executed, enable processor 504 to implement the processes of embodiments of the present invention, such as the steps in the methods discussed above. Accordingly, such computer programs represent controllers of the computer system 500. Where embodiments are implemented using software, the software may be stored in a computer program product and loaded into computer system 500 using removable storage drive 514, interface 520, or hard drive 512.

Embodiments may also be directed to computer products comprising software stored on any computer usable medium. Such software, when executed in one or more data processing device, causes a data processing device(s) to operate as described herein.

### CONCLUSION

Exemplary embodiments of the present invention have been presented. The invention is not limited to these examples. These examples are presented herein for purposes of illustration, and not limitation. Alternatives (including equivalents, extensions, variations, deviations, etc., of those described herein) will be apparent to persons skilled in the relevant art(s) based on the teachings contained herein. Such alternatives fall within the scope and spirit of the invention.

Embodiments may be implemented in hardware, software, firmware, or a combination thereof. Embodiments may be implemented via a set of programs running in parallel on multiple machines. In an embodiment, different stages of the described methods may be partitioned according to, for example, the number of documents, and distributed among the available machines.

The summary and abstract sections may set forth one or more but not all exemplary embodiments of the present invention as contemplated by the inventor(s), and thus, are not intended to limit the present invention and the appended claims in any way.

Embodiments of the present invention have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments.

What is claimed is:

1. A method of identifying non-substantive text in a document, comprising:
capturing, by a processor, one or more blocks of text from each document in a set of documents;
determining, by the processor, the frequency of occurrence for each captured block of text in the set of documents;
identifying, by the processor one or more blocks of text in the set of documents as non-substantive text when the frequency of occurrence is above a received threshold; and
tagging, by the processor, the non-substantive text in each document in the set of documents.

2. The method of claim 1, wherein the block of text is one or more lines of a document.

3. The method of claim 1, further comprising filtering, by the processor, a corpus of documents in accordance with specified criteria to create the set of documents.

4. The method of claim 1, wherein the set of documents is a first set of documents, and further comprising tagging non-substantive text in a second set of documents when the text is identified as non-substantive in the first set of documents.

5. The method of claim 1, wherein the step of determining the frequency of occurrence for each captured block in the set of documents comprises:
generating a checksum for each captured block of text in the set of documents; and
determining the frequency of occurrence for each checksum in the set of documents.

6. The method of claim 5, wherein the checksum is an MD5 checksum.

7. The method of claim 5, wherein the frequency is determined by the percentage of e-mails in which the checksum occurs.

8. The method of claim 5, wherein generating a checksum comprises generating a checksum for each unit of text in each document in a first set of documents, and tagging comprises tagging blocks of text in a second set of documents.

9. The method of claim 8, wherein the first set of documents is a subset of the second set of documents.

10. A system for identifying non-substantive text in a document, comprising:
a capturer to capture one or more blocks of text from each document in a set of documents;
a generator that generates a checksum for each captured block of text;
a calculator to calculate a frequency of occurrence of each checksum in the set of documents; and
a tagger for tagging blocks of text as non-substantive when a frequency of occurrence is above a threshold.

11. The system of claim 10, wherein the block of text is one or more lines of a document.

12. The system of claim 10, further comprising a filter module that filters a corpus of documents in accordance with specified criteria to create the set of documents.

13. The system of claim 10, wherein the generated checksum is an MD5 checksum.

14. The system of claim 10, wherein the calculated frequency of occurrence is determined by the percentage of documents in which the checksum occurs.

15. A system, comprising:
a processor; and
a memory, the memory having instructions stored thereon that, when executed by the processor, cause the processor to perform a method of identifying non-substantive text in a document, the method comprising:
capturing one or more blocks of text from each document in a set of documents;
determining the frequency of occurrence for each captured block of text in the set of documents;
identifying one or more blocks of text in the set of documents as non-substantive text when the frequency of occurrence is above a received threshold; and
tagging the non-substantive text in each document in the set of documents.

16. The system of claim 15, wherein the block of text is one or more lines of a document.

17. The system of claim 15, the method further comprising filtering a corpus of documents in accordance with specified criteria to create the set of documents.

18. The system of claim 15, wherein the set of documents is a first set of documents, and wherein the method further comprises tagging non-substantive text in a second set of documents when the text is identified as non-substantive in the first set of documents.

19. The system of claim 15, wherein the step of determining the frequency of occurrence for each captured block in the set of documents comprises:
generating a checksum for each captured block of text in the set of documents; and
determining the frequency of occurrence for each checksum in the set of documents.

20. The system of claim 19, wherein the checksum is an MD5 checksum.

21. The system of claim 19, wherein the frequency is determined by the percentage of documents in which the checksum occurs.

22. The system of claim 19, wherein the step of generating a checksum comprises generating a checksum for each unit of text in each document in a first set of documents, and the step of tagging comprises tagging blocks of text in a second set of documents.

23. The system of claim 18, wherein the first set of documents is a subset of the second set of documents.
